(19) United States
(12) Patent Application Publication
(10) Pub. No.: US 2015/0200872 A1
(43) Pub. Date: Jul. 16, 2015

(54) CLOUD RESOURCE PLACEMENT BASED ON STOCHASTIC ANALYSIS OF SERVICE REQUESTS

(71) Applicant: Cisco Technology, Inc., San Jose, CA (US)

(72) Inventors: Senhua HUANG, Fremont, CA (US); Debojyoti DUTTA, Santa Clara, CA (US); Sumit RANGWALA, Fremont, CA (US)

(73) Assignee: Cisco Technology, Inc., San Jose, CA (US)

(21) Appl. No.: 14/153,974

(22) Filed: Jan. 13, 2014

(51) Int. Cl. H04L 12/911; G06N 7/00

(52) U.S. Cl. CPC H04L 47/829; G06N 7/005

(57) ABSTRACT

In one embodiment, a method comprises determining a stochastic distribution of received service requests for services in a data network having a prescribed physical topology; and allocating virtualized resources within the prescribed physical topology for a corresponding service request, based on the stochastic distribution.

### TECHNICAL FIELD

The present disclosure generally relates to allocating data center resources in a multitenant service provider (SP) data network for implementation of a virtual data center (vDC) providing cloud computing services for a customer.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Placement of data center resources (e.g., compute, network, or storage) can be implemented in a variety of ways to enable a service provider to deploy distinct virtual data centers (vDC) for respective customers (i.e., tenants) as part of an Infrastructure as a Service (IaaS). The placement of data center resources in a multitenant environment, however, can become particularly difficult if a logically defined cloud computing service is arbitrarily implemented within the physical topology of the data center controlled by the service provider, especially if certain path constraints have been implemented within the physical topology by the service provider.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus determining an optimum placement, within the physical topology of a service provider data network, of a service request for cloud computing service operations based on a determined stochastic distribution of received service requests, according to an example embodiment.

FIG. 2 illustrates an example physical topology of the service provider data network of FIG. 1.

FIG. 3 illustrates the example apparatus of FIG. 1, according to an example embodiment.

FIG. 4 illustrates an example optimal placement, by the apparatus of FIG. 3, of a service request into a selected portion of the physical topology of FIG. 2, based on the stochastic distribution of received service requests, according to an example embodiment.

FIG. 5 illustrates an example method of determining an optimum placement, within the physical topology of a service provider data network, of a service request for cloud computing service operations for a customer based on a determined stochastic distribution of received service requests, according to an example embodiment.

FIG. 6 illustrates example attributes and probability functions utilized in the method of FIG. 4, according to an example embodiment.

### DESCRIPTION OF EXAMPLE EMBODIMENTS

### Overview

In one embodiment, a method comprises determining a stochastic distribution of received service requests for services in a data network having a prescribed physical topology; and allocating virtualized resources within the prescribed physical topology for a corresponding service request, based on the stochastic distribution.

In another embodiment, an apparatus comprises a device interface circuit configured for detecting received service requests for services in a data network having a prescribed physical topology; and a processor circuit. The processor circuit is configured for determining a stochastic distribution of the received service requests, the processor circuit further configured for allocating virtualized resources within the prescribed physical topology for a corresponding service request, based on the stochastic distribution.

In another embodiment, logic is encoded in one or more non-transitory tangible media for execution by a machine, and when executed by the machine operable for: determining a stochastic distribution of received service requests for services in a data network having a prescribed physical topology; and allocating virtualized resources within the prescribed physical topology for a corresponding service request, based on the stochastic distribution.

### DETAILED DESCRIPTION

Particular embodiments can enable optimized placement of a service request within a physical topology of a service provider data network, based on stochastic analysis of received service requests that can provide a prediction of future demands on the physical topology by future service requests relative to existing service requests. Prior methods for allocating virtualized resources to implement a service request within a physical topology have utilized only the current (or past) state of resources in the physical topology, or the current/past state of resources in the virtualized data center, to determine how to implement a received service request. In other words, none of the prior methods of allocating virtualized resources considered the probability of future service requests, and/or the subsequent future resource utilization in a data center.

According to an example embodiment, stochastic analysis is performed on received service requests, in order to obtain a stochastic distribution of the service requests. The stochastic distribution enables a predictive analysis of future service requests relative to future resource utilization in the data center. Hence, the stochastic properties of service requests (e.g., virtual data center requests) and the resource utilization in a data center can be used to allocate virtualized resources in the physical topology (e.g., select one or more data center nodes for instantiating a new vDC request). Consequently, implementation issues such as defragmentation in multi-tenant data centers, rearranging provisioned (i.e., allocated) vDC requests due to congestion, traffic surge-based congestion, migration-based congestion, etc., can be mitigated or eliminated entirely based on applying the disclosed stochastic analysis providing a predictive analysis of future service requests relative to future resource utilization.

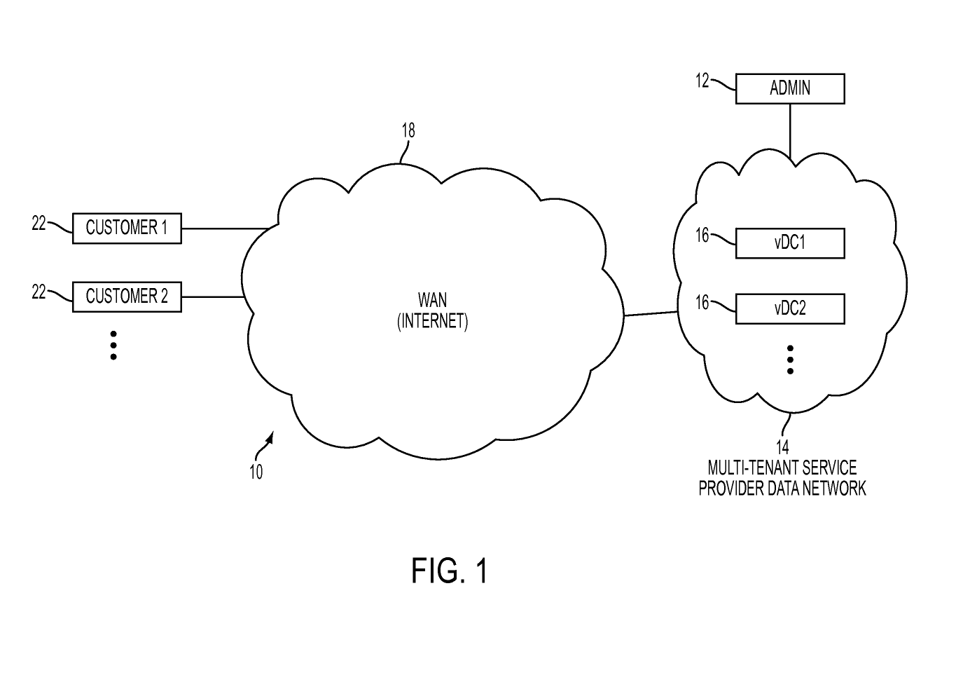

FIG. 1 is a diagram illustrating an example system 10 having an apparatus 12 for allocating virtualized resources within a service provider data network 14 for a service request, based on a stochastic distribution of received service requests, according to an example embodiment. The service request can define cloud computing service operations for a virtual data center 16. The apparatus 12 is a physical machine (i.e., a hardware device) configured for implementing data network communications with other physical machines via the service provider data network 10 and/or a wide area network (WAN) (e.g., the Internet) 18. Hence, the apparatus 12 is a network-enabled user machine providing user access to a network and implementing network communications via the network 10.

The apparatus 12 can be configured for implementing virtual data centers 16 for respective customers (i.e., tenants) in a multitenant environment, where virtual data centers 16 can be implemented within the service provider data network 14 using shared physical resources, while logically segregating the operations of the virtual data centers 16 to ensure security, etc. Each virtual data center 16 added to the service provider data network 14 consumes additional physical resources; moreover, logical requirements for a virtual data center 16 (either by the customer 22 or by service-provider policies) need to be reconciled with physical constraints within the service provider data network (e.g., bandwidth availability, topologically-specific constraints, hardware compatibility, etc.). Moreover, arbitrary allocation of physical resources in the service provider data network 14 for a virtual data center 16 may result in inefficient or unreliable utilization of resources.

According to an example embodiment, allocation of virtualized resources based on the stochastic distribution of received service requests enables the efficient and effective placement within the data center of the service request that logically defines virtual data center 16, in a manner that can minimize future implementation issues due to subsequent service requests (e.g., defragmentation, congestion, etc.).

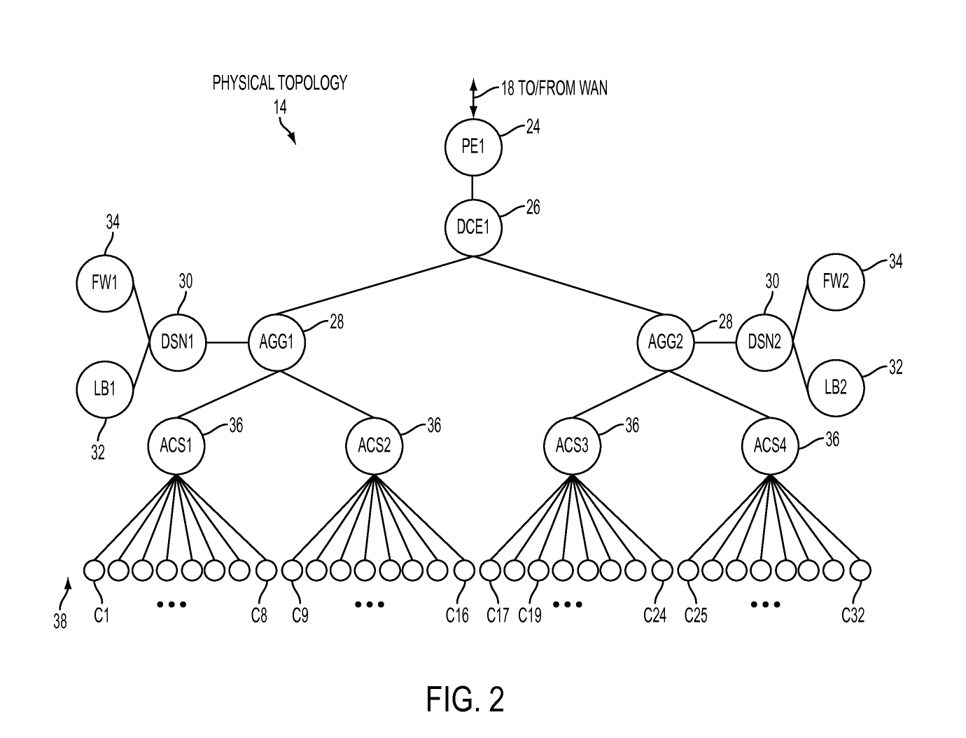

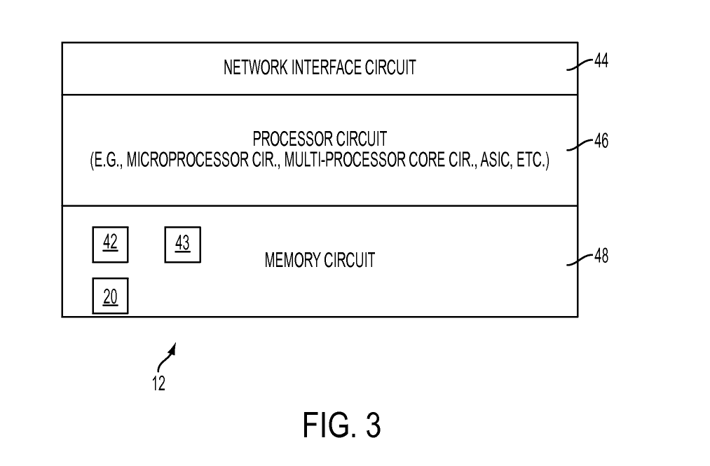

FIG. 2 illustrates an example physical topology of the service provider data network 14 of FIG. 1, according to an example embodiment. The physical topology 14 defines the link layer (layer 2) and network layer (layer 3) connectivity between physical network devices within the service provider data network. The physical topology 14, as well as service provider policies, path constraints, and inventory of available versus allocated resources are maintained by the apparatus 12 in the form of a physical graph 20 stored in a memory circuit 48 (illustrated in FIG. 3) that represents the data network 14. Hence, the physical graph 20 defines and represents all attributes of the data network 14.

As illustrated in FIG. 2, the physical topology 14 can include at least one provider edge router “PEA” 24, at least one data center edge router “DCE1” 26, aggregation switches (e.g., “AGG1”, “AGG2”) 28, data service nodes (e.g., “DSN1”, “DSN2”) 30, load balancer devices (e.g., “LB1”, “LB2”) 32, firewall nodes (physical devices or virtualized) (e.g., “FW1”, “FW2”) 34, access switches (e.g., “ACS1” to “ACS4”) 36, and compute elements (e.g., “C1” to “C32”) 38. The devices illustrated in the physical topology can be implemented using commercially available devices, for example the access switches 36 can be implemented using the commercially available Cisco Nexus 7000 or 5000 Series Access Switch from Cisco Systems, San Jose, Calif.; various physical devices can be used to implement the compute elements 38, depending on the chosen virtual data center service or cloud computing service operation to be provided (e.g., compute, storage, or network service). An example compute element 38 providing compute services could be a unified computing system (e.g., the Cisco UCS B-Series Blade Servers) commercially available from Cisco Systems.

Although not illustrated in FIG. 2, the physical graph 20 representing the data network 14 also can include an identification of attributes of each of the network devices in the data network 14, including not only hardware configurations (e.g., processor type), but also identification of the assigned service type to be performed (e.g., network service type of aggregation, firewall, load balancer, etc.; virtual data center service type of web server (“Web”), back-end application server (“App”), or back end database server (“DB”)), available resources that have not yet been assigned to a virtual data center 16 (e.g., bandwidth, memory, CPU capacity, etc.). Other attributes of the physical graph that can be specified include particular capabilities of a network device, for example whether a network switch is “layer 3 aware” for performing layer 3 (e.g., Internet protocol) operations.

Hence, the physical graph 20 can include an example inventory and attributes of the network devices in the physical topology 14, for use by the apparatus 12 in identifying feasible cloud elements based on performing stochastic-based allocation of virtualized network devices relative to the network devices based on logical constraints specified by a service request or service provider-based constraints and policies, described below.

FIG. 3 illustrates the example apparatus 12 configured for allocating virtualized resources for a service request based on a determined stochastic distribution of received service requests, according to an example embodiment. The apparatus 12 can be implemented as a single physical machine (i.e., a hardware device) configured for implementing network communications with other physical machines via the network 14 and/or 18. Alternately, the apparatus 12 can be implemented as two or more physical machines configured for implementing distributed computing based on coordinated communications between physical machines in the network 14 and/or 18.

The apparatus 12 can include a network interface circuit 44, a processor circuit 46, and a non-transitory memory circuit 48. The network interface circuit 44 can be configured for receiving, from any requestor 22, a request for a service such as a service request 42 from a customer 22. The network interface circuit 44 also can be configured for detecting received service requests 42 based on accessing a request cache storing incoming service requests received over time.

The network interface circuit 44 also can be configured for sending requests initiated by the processor circuit 46 to targeted network devices of the service provider data network 14, for example XMPP requests for configuration and/or policy information from the management agents executed in any one of the network devices of the service provider data network; the network interface 44 also can be configured for receiving the configuration and/or policy information from the targeted network devices. The network interface 44 also can be configured for communicating with the customers 22 via the wide-area network 18, for example an acknowledgment that the service request 42 has been deployed and activated for the customer 22. Other protocols can be utilized by the processor circuit 46 and the network interface circuit 44, for example IGP bindings according to OSPF, IS-IS, and/or RIP protocol; logical topology parameters, for example BGP bindings according to BGP protocol; MPLS label information according to Label Distribution Protocol (LDP); VPLS information according to VPLS protocol, Asynchronous Transfer Mode (ATM) switching, and/or AToM information according to AToM protocol (the AToM system is a commercially-available product from Cisco Systems, San Jose, Calif., that can transport link layer packets over an IP/MPLS backbone).

The processor circuit 46 can be configured for executing a Cisco Nexus platform for placement of the service request 42 into the physical topology 14, described in further detail below. The processor circuit 46 also can be configured for creating, storing, and retrieving from the memory circuit 48 relevant data structures, for example the physical graph 20, a collection of one or more service requests 42 received over time, and metadata 43 describing the physical graph 20 and/or the service requests 42, etc. As described in further detail below, the metadata 43 can include a stochastic distribution of received service requests 42, determined by the processor circuit 46. The memory circuit 48 can be configured for storing any parameters used by the processor circuit 46, described in further detail below.

Any of the disclosed circuits (including the network interface circuit 44, the processor circuit 46, the memory circuit 48, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 48) causes the integrated circuit(s) implementing the processor circuit 46 to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 48 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (e.g., in a receive buffer). Also note that the memory circuit 48 can be implemented dynamically by the processor circuit 46, for example based on memory address assignment and partitioning executed by the processor circuit 46.

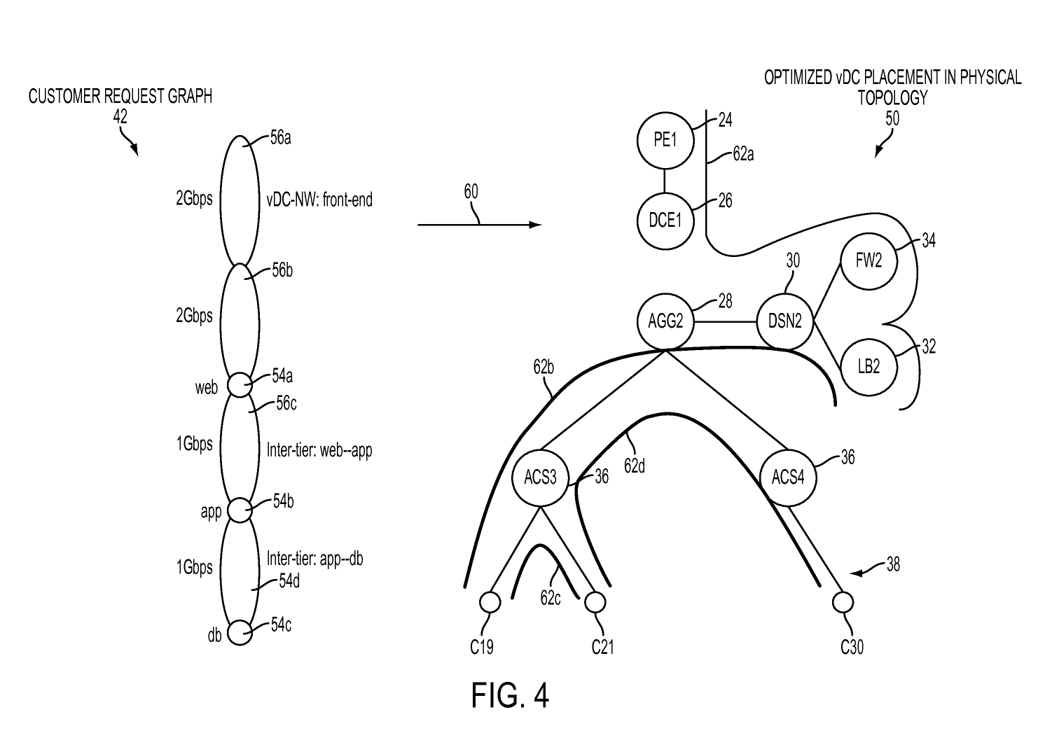

FIG. 4 illustrates an example optimal placement 50 of a service request 42 by the processor circuit 46 into a selected portion of the physical topology 14 of the service provider data network based on a determined stochastic distribution of service requests, according to an example embodiment.

The service request 42 can specify request nodes 54 (e.g., 54a, 54b, and 54c) and one or more request edges 56 (e.g., 56a, 56b, 56c, and 56d). Each request node 54 can identify (or define) at least one requested cloud computing service operation to be performed as part of the definition of the virtual data center 16 to be deployed for the customer. For example, the request node 54a can specify the cloud computing service operation of “web” for a virtualized web server; the request node 54b can specify the cloud computing service of “app” for virtualized back end application services associated with supporting the virtualized web server; the request node 54c can specify the cloud computing service of “db” for virtualized database application operations responsive to database requests from the virtualized back end services. Each request node 54 can be associated with one or more physical devices within the physical topology 14, where typically multiple physical devices may be used to implement the request node 54.

Each request edge 56 can specify a requested path requirements connecting two or more of the request nodes 54. For example, a first request edge (“vDC-NW: front-end) 56a can specify logical requirements for front-end applications for the virtual data center 16, including firewall policies and load-balancing policies, plus a guaranteed bandwidth requirement of two gigabits per second (2 Gbps); the request edge 56b can specify a requested path requirements connecting the front end to the request node 54a associated with providing virtualized web server services, including a guaranteed bandwidth requirement of 2 Gbps; the request edge 56c can specify a requested path providing inter-tier communications between the virtualized web server 54a and the virtualized back end application services 54b, with a guaranteed bandwidth of 1 Gbps; and the request edge 56d can specify a requested path providing inter-tier communications between the virtualized back and application services 54b and the virtualized database application operations 54c, with a guaranteed bandwidth of 1 Gbps. Hence, the service request 42 can provide a logical definition of the virtual data center 16 to be deployed for the customer 22.

Depending on implementation, the request edges 56 of the service request 42 may specify the bandwidth constraints in terms of one-way guaranteed bandwidth, requiring the service provider to sufficient bandwidth between physical network nodes implementing the request nodes 54. Further, the physical topology 14 may include many different hardware configuration types, for example different processor types or switch types manufactured by different vendors, etc. Further, the bandwidth constraints in the physical topology 14 must be evaluated relative to the available bandwidth on each link, and the relative impact that placement of the service request 42 across a given link will have with respect to bandwidth consumption or fragmentation. Further, service provider policies may limit the use of different network nodes within the physical topology: an example overlay constraint may limit network traffic for a given virtual data center 16 within a prescribed aggregation realm, such that any virtual data center 16 deployed within the aggregation realm serviced by the aggregation node “AGG1” 28 can not interact with any resource implemented within the aggregation realm service by the aggregation node “AGG2” 28; an example bandwidth constraint may require that any placement does not consume more than ten percent of the maximum link bandwidth, and/or twenty-five percent of the available link bandwidth.

In addition to the foregoing limitations imposed by the customer service request and/or the service provider policies, arbitrary placement of the customer service request 42 within the physical topology 14 may result in reversal of network traffic across an excessive number of nodes, requiring an additional consumption of bandwidth along each hop.

According to an example embodiment, the processor circuit 46 can determine a stochastic distribution of the received service requests 42. The processor circuit 46 also can allocate in operation 60 of FIG. 4 virtualized resources within the physical topology 14 based on the determined stochastic distribution of received service requests 42, resulting in the optimized placement 50 of the customer virtual data center 16 according to the service request 42. The determined stochastic distribution of received service requests 42 enable a predictive analysis of future service requests relative to future resource utilization in the data centers 16 and the physical topology 14.

Hence, the processor circuit 46 can use predictive analysis to allocate virtualized resources 50. As illustrated in FIG. 4, the processor circuit can use predictive analysis to allocate virtualized resources 50 for a virtual data center 16, including for example the compute node “C19” 38 as a feasible cloud element for the request node 54a; the compute node “C21” as a feasible cloud element for the request node 54b, and the compute node “C30” as a feasible cloud element for the compute node 54c. Hence, the request edge 56a can be deployed along the multi-hop network path 62a; the request edge 56b can be deployed along the network path 62b; the request edge 56c can be deployed along the network path 62c; and the request edge 56d can be deployed along the network path 62d.

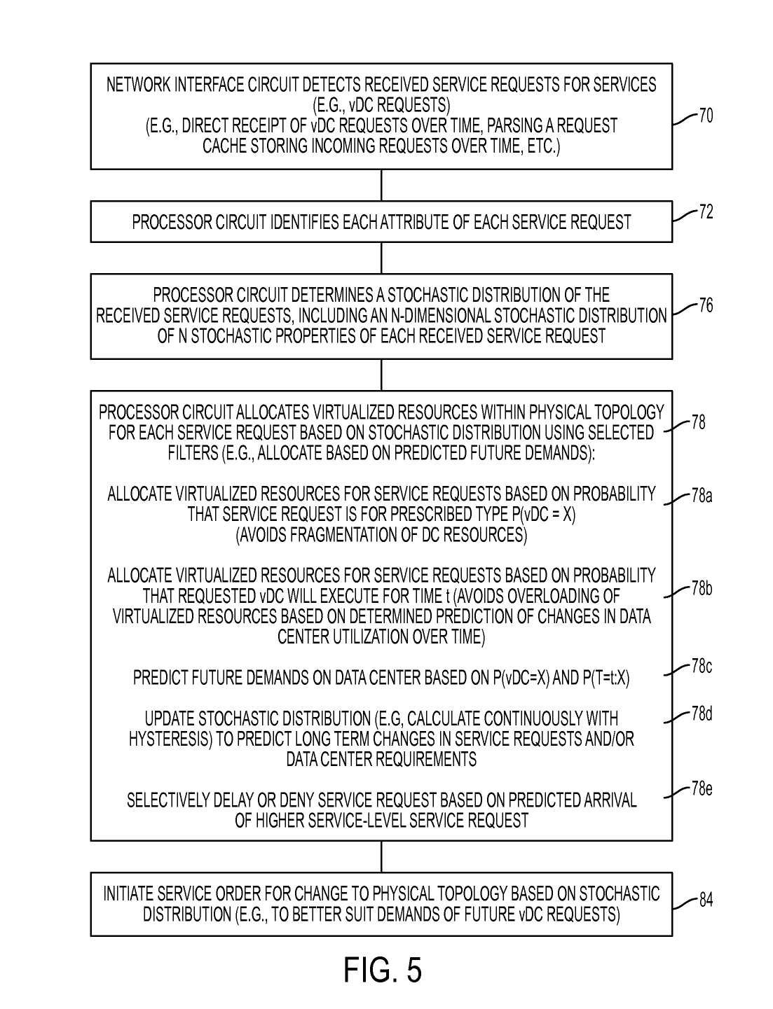

FIG. 5 illustrates an example method summarizing the allocation of virtualized resources 50 based on a stochastic distribution 43 of the received requests 42, according to an example embodiment. The operations described with respect to any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

Referring to FIG. 5, the network interface circuit 44 can detect received service requests 42 for virtualized services in the data network 14. The detection of service requests 42 by the device interface circuit 44 can be based on direct receipt of the vDC requests 42 over time, and/or parsing an external request cache (not shown) that stores the received vDC requests 42 over time, etc.

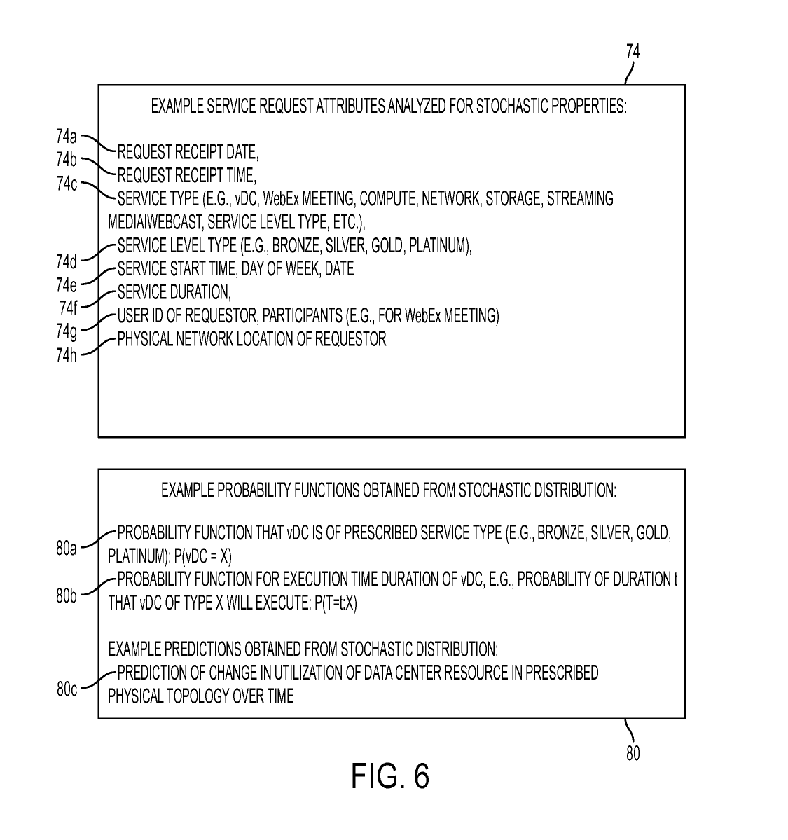

The processor circuit 46 in operation 72 can identify each attribute of each service request 42, as described above with respect to FIG. 4, for stochastic analysis. Example attributes can include the nodes 54a, 54b, and 54c specified in the request 42, and the request edges 56a, 56b, 56c, and 56d. Additional example attributes 74 are illustrated in FIG. 6, including a request receipt date 74a, a request receipt time 74b, a service type 74c describing a prescribed type of service (e.g., vDC; WebEx Meeting; Compute, Network and/or Storage; Streaming Media or Webcast service, Service Level Type 74d). Example service level types 74d can include a low-cost “bronze” service, a higher-grade “silver” service, a higher-grade “gold” service, and/or a premium-level “platinum” service. Additional example attributes can include parameters describing the period in time in which the virtualized resources are to be executed for the virtualized service, for example a service start time (by start time, day of week, and/or date, depending on the service type) 74e, and/or a service duration 74f specifying the requested duration of the virtualized service. Additional example attributes can include one or more user identifiers 74g for each requestor (and/or participants, for example in the case of a WebEx meeting), the physical and/or network location 74h of the requestor, for example for locality-based optimization of the allocation of virtualized resources.

The processor circuit 46 in operation 76 of FIG. 5 can determine a stochastic distribution (stored in the data structure 43 of FIG. 3) of the received service requests 42: the stochastic distribution 43 can be an N-dimensional distribution function (across the domain of some or all N possible nondeterministic attributes of the service requests 42) that enables a probabilistic determination of future states of any of the nondeterministic attributes, in any combination or permutation. Hence, the processor circuit 46 in operation 78 can allocate virtualized resources 50 (operation 60 of FIG. 4) within the physical topology 14 of FIG. 2 based on the stochastic distribution 43 of the received service requests 42 enabling a predictive analysis of future service requests relative to future resource utilization in the data center (as represented in the data structure 20 of FIG. 3). For example, the processor circuit 46 can apply selected filters using one or more of the N dimensions of the stochastic distribution 43, where the stochastic distribution with respect to a particular attribute can be referred to as a probability function 80, illustrated in FIG. 6.

Example allocations in operation 78 based on the stochastic distribution 43 can include the processor circuit 46 allocating virtualized resources 50 based on a probability function “P(vDC=X)” (80a of FIG. 6) that the service request 42 is for a prescribed type “X” 74c and/or service level 74d (operation 78a): the allocating 78a can enable “bundling” of similarly-typed service requests 42, avoiding the fragmentation of data center resources. Another example allocation can include the processor circuit 46 allocating virtualized resources 50 based on a probability function 80b “P(T=t:X)” that the requested vDC 16 (e.g., of type “X”) will execute for a time “t” (operation 78b): the allocating 78b can reduce or avoid overloading of virtualized resources based on the determined prediction of changes in data center utilization over time. Another example allocation 78c can include predicting future demands on the data center based on the probability functions 80a and/or 80b: the predicted future demands can be used to construct a timetable (stored in the memory circuit 48) of future available virtualized resources, enabling determination of whether virtualized resources will be available for fulfilling a future service request. Another example allocation can include updating continuously (operation 78d) the stochastic distribution 43 (e.g., using hysteresis) to predict long term changes in service requests 42 and/or data center requirements. Another example allocation 78e can include the processor circuit 46 selectively delaying or denying a service request (e.g., a bronze-level request) 42 based on a predicted arrival of a higher service-level service request (e.g., a platinum-level request) 42.

Hence, the allocations in operation 78 based on the stochastic distribution 43 of service requests 42 can enable efficient deployment of virtual data centers 16, without the necessity of modifying or moving provisioned virtual data centers 16 due to an increase in service requests 42 or consumed resources. Further, system overhead can be reduced by mitigating fragmentation of resources that need to be reclaimed after termination of a virtual data center 16. The allocation based on different service levels also can enable an improvement in revenue by favoring higher service level requests (e.g., gold over platinum) based on the predictions from the stochastic distribution.

The processor circuit 46 also can initiate in operation 84 a service order (e.g., to a Provisioning Manager) to change the physical topology 14 based on the stochastic distribution 43, for example based on detecting that the current physical topology (as represented by the physical graph 20) needs to be modified to better suit future vDC requests 42.

According to the example embodiments, cloud resource placement in a physical topology of a service provider data network can be optimized based on a determined stochastic distribution of the received service requests, enabling the mitigation or elimination of fragmentation, congestion, re-provisioning due to congestion, etc.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
determining a stochastic distribution of received service requests for services in a data network having a prescribed physical topology; and
allocating virtualized resources within the prescribed physical topology for a corresponding service request, based on the stochastic distribution.

2. The method of claim 1, wherein the determining includes determining the stochastic distribution relative to attributes associated with each service request, the attributes including at least one of service type, service level, service start time, or service duration.

3. The method of claim 1, wherein the determining the stochastic distribution includes determining a probability of service duration for a corresponding service type.

4. The method of claim 1, wherein each service request is associated with virtualized data center services, the stochastic distribution including a first probability function that a virtualized data center is of a prescribed type, and a second probability function that a virtualized data center will be executed relative to a time duration, the second probability function enabling a prediction of the time duration of utilizing data center resources in the prescribed physical topology.

5. The method of claim 4, wherein the first probability function and the second probability function enable a prediction of future demands for the data center resources in the prescribed physical topology, the allocating including determining, from a timetable constructed based on the stochastic distribution, whether virtualized resources will be available for fulfilling the service request.

6. The method of claim 5, wherein the allocating includes selectively delaying or denying the service request, relative to other service requests, based on the prediction of future demands relative to whether the resources will be available, and based on at least one other attribute distinguishing the denied service request relative to service requests to be allocated the virtualized resources.

7. The method of claim 6, wherein the one other attribute distinguishes between service levels, the denied service request having a lower service level than the service requests to be allocated the virtualized services.

8. An apparatus comprising:
a device interface circuit configured for detecting received service requests for services in a data network having a prescribed physical topology; and
a processor circuit configured for determining a stochastic distribution of the received service requests, the processor circuit further configured for allocating virtualized resources within the prescribed physical topology for a corresponding service request, based on the stochastic distribution.

9. The apparatus of claim 8, wherein the processor circuit is configured for determining the stochastic distribution relative to attributes associated with each service request, the attributes including at least one of service type, service level, service start time, or service duration.

10. The apparatus of claim 8, wherein the processor circuit is configured for determining, as part of the stochastic distribution, a probability of service duration for a corresponding service type.

11. The apparatus of claim 8, wherein each service request is associated with virtualized data center services, the stochastic distribution including a first probability function that a virtualized data center is of a prescribed type, and a second probability function that a virtualized data center will be executed relative to a time duration, the second probability function enabling a prediction of the time duration of utilizing data center resources in the prescribed physical topology.

12. The apparatus of claim 11, wherein the first probability function and the second probability function enable a prediction of future demands for the data center resources in the prescribed physical topology, the processor circuit configured for allocating the virtualized resources based on determining, from a timetable constructed based on the stochastic distribution, whether virtualized resources will be available for fulfilling the service request.

13. The apparatus of claim 12, wherein the processor circuit is configured for allocating the virtualized resources based on selectively delaying or denying the service request, relative to other service requests, based on the prediction of future demands relative to whether the resources will be available, and based on at least one other attribute distinguishing the denied service request relative to service requests to be allocated the virtualized resources.

14. Logic encoded in one or more non-transitory tangible media for execution by a machine and when executed by the machine operable for:
determining a stochastic distribution of received service requests for services in a data network having a prescribed physical topology; and
allocating virtualized resources within the prescribed physical topology for a corresponding service request, based on the stochastic distribution.

15. The logic of claim 14, wherein the determining includes determining the stochastic distribution relative to attributes associated with each service request, the attributes including at least one of service type, service level, service start time, or service duration.

16. The logic of claim 14, wherein the determining the stochastic distribution includes determining a probability of service duration for a corresponding service type.

17. The logic of claim 14, wherein each service request is associated with virtualized data center services, the stochastic distribution including a first probability function that a virtualized data center is of a prescribed type, and a second probability function that a virtualized data center will be executed relative to a time duration, the second probability function enabling a prediction of the time duration of utilizing data center resources in the prescribed physical topology.

18. The logic of claim 17, wherein the first probability function and the second probability function enable a prediction of future demands for the data center resources in the prescribed physical topology, the allocating including determining, from a timetable constructed based on the stochastic distribution, whether virtualized resources will be available for fulfilling the service request.

19. The logic of claim 18, wherein the allocating includes selectively delaying or denying the service request, relative to other service requests, based on the prediction of future demands relative to whether the resources will be available, and based on at least one other attribute distinguishing the denied service request relative to service requests to be allocated the virtualized resources.

20. The logic of claim 19, wherein the one other attribute distinguishes between service levels, the denied service request having a lower service level than the service requests to be allocated the virtualized services.
